(19) United States
(12) Patent Application Publication
(10) Pub. No.: US 2009/0037342 A1
(43) Pub. Date: Feb. 5, 2009

(54) SYSTEMS & METHODS FOR DETERMINING A VALUE OF AN INTELLECTUAL ASSET PORTFOLIO

(75) Inventor: JOHN T. KENNEDY, DENVER, CO (US)

Correspondence Address: INGRASSIA FISHER & LORENZ, P.C. (DISH), 7010 E. COCHISE ROAD, SCOTTSDALE, AZ, 85253-1406, US

(73) Assignee: ECHOSTAR SATELLITE LLC, Englewood, CO (US)

(21) Appl. No.: 11/831,095

(22) Filed: Jul. 31, 2007

(51) Int. Cl. G06Q 40/00

(52) U.S. Cl. 705/36 R

(57) ABSTRACT

Systems and methods determine an aggregate value of a portfolio of patents or other intellectual assets based upon a number of ratings. Each rating is determined with respect to one of a group of categories for each of the intellectual assets in the portfolio, including a category representing the claim strength of the asset being evaluated. For each of the intellectual assets in the portfolio, inputs corresponding to one of the plurality of ratings assigned to the asset are received. A value for each of the intellectual assets is computed as a function of the input representing the claim strength of the intellectual asset, adjusted by the other inputs for that intellectual asset. The aggregate value of the portfolio of intellectual assets is output as a function of the values of each of the intellectual assets in the portfolio.

### TECHNICAL FIELD

The present invention generally relates to valuation of patents and other intellectual assets, and more particularly relates to systems and methods for determining the value of an intellectual asset that may be contained within a portfolio of assets.

### BACKGROUND

As modern economies move further into information-based systems of capital, intellectual assets such as patents, industrial designs, copyrights and trademarks continue to represent a large portion of society's wealth. Indeed, a majority of the book value in many corporations and other business entities is now represented by “goodwill” and other forms of intangible wealth, much of which commonly resides in a portfolio of patents, designs, know-how and other legal rights. It is also common for businesses and individuals to transfer intellectual assets between each other in the form of licenses, assignments of rights, and the like.

In modern business, then, it is often desired to accurately assess the value of one or more patents or other intellectual assets. This valuation may be helpful in ascertaining a value of a company, for example, or it may simply be used to assess the value of assets identified for purchase or license. Difficulty arises, however, in accurately estimating the value of intellectual assets due to the unique nature of such assets, the confidentiality that typically obscures comparisons to comparable asset transfers, and the inherently subjective nature of assigning monetary values to intangible items. Although various economists and other “experts” in the field have attempted to value particular assets using various techniques, a complex economic analysis can be prohibitively expensive for many common transactions, particularly those involving multiple assets. As a result, common valuation techniques are often inappropriate or inconvenient for many practical purposes.

It is therefore desirable to create systems and techniques for determining the value of an intellectual asset in quantifiable terms. Such systems and techniques should be convenient to implement, particularly in evaluating multiple assets contained within a portfolio. These and other desirable features and characteristics will become apparent from the subsequent detailed description and the appended claims, taken in conjunction with the accompanying drawings and this background section.

### BRIEF SUMMARY

According to various embodiments, systems and methods are provided to determine an aggregate value of a portfolio of patents, industrial designs or other intellectual assets based upon a number of ratings assigned to each asset. Each rating is determined with respect to one of a group of categories for each of the intellectual assets in the portfolio, including a category representing the claim strength of the asset being evaluated. For each of the intellectual assets in the portfolio, inputs corresponding to one of the plurality of ratings assigned to the asset are received. A value for each of the intellectual assets is computed as a function of the input representing the claim strength of the intellectual asset, adjusted by the other inputs for that intellectual asset. The aggregate value of the portfolio of intellectual assets is output as a function of the values of each of the intellectual assets in the portfolio.

In other embodiments, systems and methods are provided to determine a value of an intellectual asset based upon multiple ratings, with each rating determined with respect to one of any number of categories. The categories include any number of market-related categories. A number of inputs are received, with each input corresponding to one of the plurality of ratings assigned to the intellectual asset. Each of the inputs received with respect to the market-related categories for the asset are added or otherwise aggregated to thereby compute an overall market rating for each of the intellectual assets. The value of the intellectual asset is determined as a function of the overall market rating, and is displayed or otherwise output as appropriate.

Other embodiments include computer program products and digital storage media having computer-executable instructions stored thereon. Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary valuation program implemented in a computer spreadsheet application; and

FIG. 2 is a flowchart of an exemplary technique for determining the value of a portfolio of intellectual assets.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Various embodiments present systems, methods, computer program products and other useful features for determining a value of one or more intellectual assets. The structures and techniques set forth below generally provide a framework for obtaining valuations of assets based upon an objective framework which utilizes relatively subjective factors provided by an evaluator of one or more intellectual assets. While subjectivity remains an element of many embodiments, the objective framework structure provides for consistency in processing and divides the subjective criterion across various categories, thereby reducing variability in results. Moreover, various techniques and structures described below may be readily implemented in a conventional computer spreadsheet program or the like, thereby providing ease of implementation and very convenient scaling to portfolios containing any number of assets.

As a preliminary matter, it should be pointed out that much of the discussion contained within this detailed description and the associated drawing figures focuses on a particular exemplary embodiment dealing with the valuation of a portfolio of United States patents. This example is solely to ease understanding of the broader concepts contained herein, however, which may be applied to any type of intellectual assets, including assets that are domestic and/or foreign to any particular nation or other jurisdiction. References herein to “intellectual assets”, then, are therefore intended to broadly encompass domestic or foreign patents, patent applications, industrial designs, trade secrets, know-how, show-how, copyrights, trademarks, service marks, and/or any other types of registerable or unregisterable intellectual or other intangible properties that exist or manifest anywhere in the world.

To that end, the concepts proposed herein may be applied to any valuation system for any portfolio of intangible assets, and may be readily modified as appropriate to suit any number of currency values, jurisdictional requirements, and/or other individual preferences and parameters. In particular, the exemplary data values and other parameters described herein (including in the various tables presented below) are strictly examples, and are not intended to limit the scope of the present invention in any way. Various alternate but equivalent embodiments may therefore apply to any type or number of domestic or foreign assets, with any number of parameter values or factors being selected, scaled or otherwise processed in any appropriate manner.

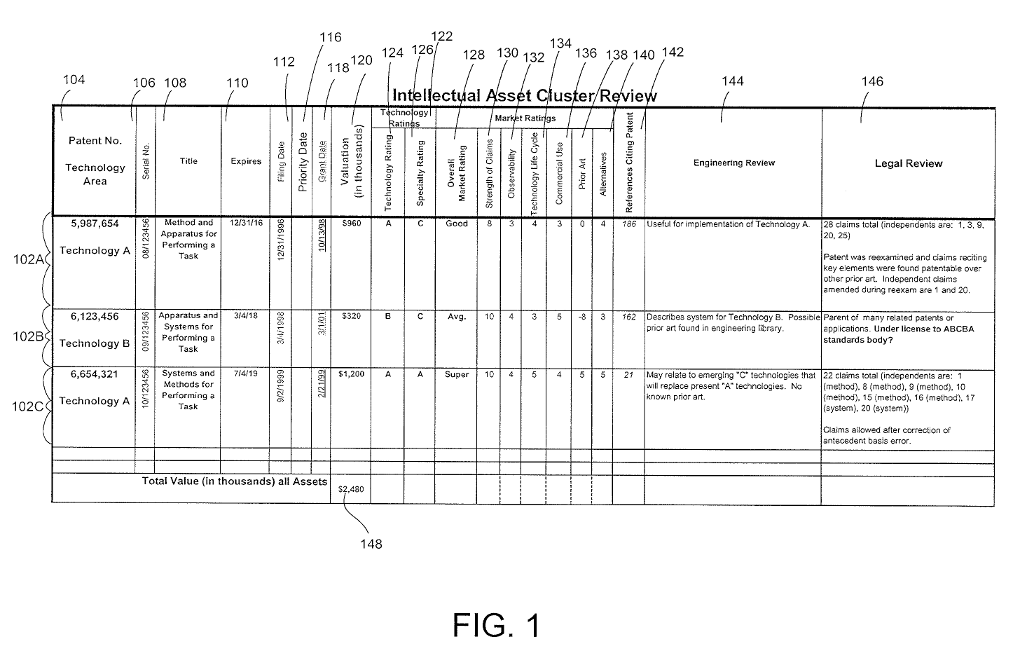

Turning now to the drawing figures and with initial reference to FIG. 1, one exemplary system 100 for determining the value of one or more intellectual assets is shown in row-column format suitable for implementation in a conventional computer spreadsheet program or the like. The particular implementation shown in FIG. 1 includes any number of system rows corresponding to various patents or other assets 102A-C, and columns 104-146 providing various categories of information about each asset 102. Reference signs 104-146 in FIG. 1 are shown referencing column title cells for ease of reference. In this text, however, these column references may apply to data or information contained in the cells below the column headings as well. Generally speaking, many of the cells below column headings 104-118 and 130-146 will contain data inputs provided by a user to the system, with information in the remaining cells (e.g. those under columns 120-128 shown in FIG. 1) being computed by processing logic as described more fully below. Examples of spreadsheet applications that may be readily adapted as described herein include the EXCEL program available from the MICROSOFT Corporation of Redmond, Wash., the GOOGLE spreadsheet program available from the GOOGLE Corporation of Mountain View, Calif., and/or the like. In other embodiments, however, any sort of interface or “front end” could prompt the user to enter any sorts of inputs or otherwise allow for the receipt of user-input data in graphical, textual, numeric, alphanumeric or any other format, with conversion to numerical or other suitable processing formats being performed after such values are entered by the user. Still other embodiments may be implemented using any sort of programming or scripting features of any computer application, programming environment and/or other logic associated with any computing platform whatsoever.

Columns 104-118 in the system 100 of FIG. 1 are shown to contain demographic or other descriptive information about each asset 102A-C. Column 104, for example, contains a “Patent Number” or other identifier, and optionally also contains an alphanumeric or other technology identifier (e.g. “Technology A”) as appropriate. The technology identifier may be moved to a separate column in alternate embodiments to improve sorting ability or the like. The technology identifier, in at least one embodiment, provides a short description of the technical field to which any given intellectual asset pertains. By providing broad technical fields and identifying assets pertaining thereto, business managers can quickly identify from an often large portfolio, those intellectual assets in which they are then interested. For example, intellectual assets pertaining to “Technology A” can be grouped, sorted or the like for ease of review, comparison and analysis. Columns 106 and 108 are shown to similarly contain an asset serial number or title, respectively, with other columns showing dates of interest such as an expiration date (column 110), filing date (column 112), priority date (column 114), grant date (column 118) and/or other data as appropriate. The data contained in the various columns 104-118 may be combined, modified and/or eliminated as appropriate in other embodiments. Further, hyper-links and other forms of cross-referencing can be used to classify or identify intellectual assets having a shared or common progeny. For example, the intellectual asset identified in row 102B (U.S. Pat. No. 6,123,456) may be a continuation application of the intellectual asset identified in row 102A (U.S. Pat. No. 5,987,654). One or more hyperlinked or otherwise indicators, such as a priority date, a star “*”, the word “con,” or the like, can be provided in row 102B, column 116 to indicate that U.S. Pat. No. 6,123,456 claims priority to and is a continuation of U.S. Pat. No. 5,987,654. It is to be appreciated that, in essence, the method provides for creating relationships between intellectual assets. Such relationships can be mapped and presented graphically in a tree or otherwise structure using relationship mapping techniques.

Asset data in columns 104-118 may be manually entered by a user in some embodiments. In other embodiments, some or all of the data contained in any columns 104-118 may be automatically retrieved from an online or other database, or may be computed based upon data contained in other cells. For example, upon entry of an application serial number for a published U.S. patent application into the United States Patent and Trademark Office's (“USPTO”) Public Pair interface, information relevant to columns 140, 108, 112, 118, 120 and 142 can be obtained. Such information is commonly provided by the USPTO in HTML format and can be automatically scrapped from and inserted into the system 100 using well known HTML field readers. Further, expiration dates (column 110), for example, may be computed based upon filing dates 112, priority dates, grant dates 118, whether extensions of term were or were not granted and/or other factors as appropriate. Thus, it is to be appreciated that the systems and processes may be modified, as desired, to provide for a much or a little user input as is desired for any given implementation.

Certain embodiments may use expiration date or another indication of remaining asset life as one factor in determining the value of that asset, as appropriate. For example, a weighting factor may be associated with an expiration date such that when all other factors are equivalent, an asset with a longer term remaining is valued higher than one with a shorter term. Similarly, valuation weighting factors can also be associated with the grant date provided in column 118. For example, a patent asset granted four to six years prior to the date the asset valuation occurs may result in a higher valuation because a stronger possibility for past damage (which negates some design around potential) exists, whereas a recently granted patent may have no possibility of past damages associated with it, and thereby a higher possibility of design around exists, which would thereby diminish the value of the asset.

In many embodiments, however, it is generally not necessary that all of the data in columns 104-118 be present or complete if the information is not used in the computation of asset value.

The spreadsheet format of system 100 may also provide a convenient space for notes or other additional information, such as the “Engineering Review” notes shown in column 144 and the “Legal Review” notes shown in column 146, although these features are not generally used in value determinations, and therefore may not be provided (or may be provided in different locations) in other embodiments. To that end, the overall look and format of system 100 may vary significantly from that shown in FIG. 1 due to variations in user preferences, design choice, implementation parameters, project requirements and/or the like.

In other embodiments, fields in columns 144 and/or 146 can be utilized to drive the valuation of other rating factors used to value the intellectual asset. For example, a series of check boxes, selection ovals, questions (with entry fields) or the like can be used to solicit opinions from engineers, business persons, lawyers or anyone else reviewing any given intellectual asset. Such entries can then be used automatically or manually to select technology, specialty, market and/or other ratings. For example, an engineer examining an intellectual asset, such as know-how, may identify that the asset can be applied to multiple products, systems or the like. Such an ubiquitous asset can then be ranked accordingly in one or more technology, specialty or market rating categories.

In the embodiment shown in FIG. 1, information residing in columns 120-142 is involved in the computation of the value of each asset, with the resulting asset values for each asset 102A-C being stored in column 120. The arrangement and appearance of the various cells and columns used to compute the values 120 may differ significantly form those shown in the exemplary system 100 in FIG. 1, with processing columns 120-128 being located to the right of market value columns 130-140, for example, or otherwise located as appropriate. Indeed, the particular columns and data used in computing the various asset values 120 may be modified significantly from those shown in FIG. 1.

Valuations 120 may be calculated or otherwise determined in any manner. In various embodiments, the valuations 120 for each asset 102A-C in the portfolio are computed as functions of market ratings 128, technology rating(s) 122, and/or references rating 142, each of which are described in more detail below. Any number of sub-ratings may be utilized to determine the technology and market ratings. In the embodiment shown in FIG. 1, an overall market rating 128 based upon data contained in columns 130-140 is compared to a number of threshold values to assign an initial “base value” to the asset 102. This base value is then adjusted using technology factor(s) 122 and/or references factor 142, as appropriate, to arrive at the overall value 120 for the asset 102. The overall market rating 128 therefore provides a categorical “starting point” for further valuation based upon a number of market related factors 130-140.

Each of the evaluation categories/factors described herein may be implemented in any manner. In various embodiments, some or all of the categories are defined with respect to various “ratings” that may correspond to any sort of objective or non-objective basis. That is, the various rating criteria can be defined objectively or otherwise prior to evaluation, with the subsequent evaluator providing a comparatively subjective rating for each asset 102 based upon the criteria associated with the various categories. Exemplary guidelines for various criteria are provided below. In practice, the criteria, guidelines and/or other elements defined with respect to one or more categories may be implemented using additional rows and/or columns of a spreadsheet or other system 100 for ease of reconfiguration. In other embodiments, software logic within system 100 may implement any sort of criteria, parameters, definitions or limits on each data category. In still other embodiments, user inputs can be scaled or otherwise provided as appropriate so that limitations on criteria or other factors need not be separately implemented in software or other logic associated with system 100.

Although the particular market factors 130-140 and the relative scaling of the factors with respect to each other can vary from embodiment to embodiment, the exemplary system 100 shown in FIG. 1 includes a “claim strength” factor 130, an “observability” factor 132, a “technology life cycle” factor 134, a “commercial use” factor 136, a “prior art” factor 138, and an “alternatives” factor 140. A user inputs data corresponding to ratings for each asset in each category, and the overall market value 120 is determined based upon the information entered for each asset 102. In embodiments wherein the data for each market factor 130-140 is entered numerically, the overall market factor 120 can be readily computed as a sum, product or other mathematical function of the input data. In other embodiments, alphanumeric or other inputs provided by the user are readily converted to numerical values, which may then be used to process the overall market values 120. Again, other embodiments may use different categories altogether, may supplement these categories as appropriate and/or may eliminate any number of categories shown.

The “Claim Strength” factor 130 is any representation of the strength of subject matter covered or “claimed” by the particular asset 102 in the portfolio. In various embodiments, claim strength factor 130 is a representation of claim strength as measured by the difficulty in designing around the asset, the breadth of the claims themselves (e.g. the lack of narrow limitations, difficulties in interpretation, etc.) and/or other considerations as appropriate. In one embodiment, the claim strength factor can be assigned by the user on any basis, such as the table of exemplary value assignment guidelines shown in Table 1:

TABLE 1

| | |
|---|---|
| Strong claims, very difficult design around | 10 |
| Good, broad, difficult design around | 8 |
| Average, limited scope | 6 |
| Weak, specific, narrow claims | 4 |
| Poor, hard to interpret | 0 |

In the embodiment shown in Table 1, the claim strength factor 130 varies from a minimum value (e.g. zero) to a maximum value (e.g. ten), with various categories in between. Other embodiments may use widely differing numerical values, ranges and/or categorical descriptions without departing from the general concept of assigning a numerical value to the claim strength of the asset 102.

When used in conjunction with patents and patent applications, the claim strength factor 130 will most likely be assessed by one skilled in reading patent claims. Such a person might be an engineer, patent agent, patent attorney, licensing professional or the like. Given the fact that the number and types of claims present may vary significantly from one given patent to the next, it is to be appreciated that this factor is somewhat subjective. The above defined ratings however provide guidelines an evaluator can use such that, to the extent reasonably possible, objective criteria are utilized.

Like the claim strength factor 130, the observability factor 132 provides numerical representation based upon user input. Observability in this sense relates to a level of difficulty in identifying products or activities covered by assets 102, and may be scaled with respect to the other market factors 130-140 to provide any desired level of influence on the overall market value. In one exemplary embodiment, values of observability factor 132 may be assigned using guidelines contained in Table 2:

TABLE 2

| | |
|---|---|
| Advertised or standard feature | 5 |
| Disassemble commercially-available product | 4 |
| Black box analysis required | 3 |
| Intense reverse engineering required | 2 |
| Legal discovery required | −5 |

In the embodiment of Table 2, the observability factor varies by a range of 5 to −5, thereby ranging in value between a positive value equal to an average of the minimum and maximum values of the claim strength factor and a negative value equal to the inverse of that average value. While these values may vary relative to each other and to the other market factors 130-140 in other embodiments, the exemplary values in Table 2 illustrate that the numerical values assigned to this or any other market value factor 130-140 need not be linearly assigned within the category itself, and may be assigned in a manner that provides appropriate relative value for the category or any individual criterion. Table 2, for example, shows that variation between the top four values is relatively slight, but with a substantial variation imposed if legal discovery is deemed to be required to detect infringing activity. Similar concepts may be applied to other criterion or factors as appropriate.

The technology life cycle factor 134 in FIG. 1 represents the relevant life remaining for the asset 102. Technology life cycle may be determined subjectively with regard to perceived maturity of the relevant technical field, and/or may be determined using objective factors such as the remaining life of the asset (e.g. as expressed in or determined from column 110). Exemplary subjective criterion for the technology life cycle factor could be assigned in accordance with the guidelines set forth in Table 3:

TABLE 3

| | |
|---|---|
| Next generation | 5 |
| Growth | 4 |
| Mature | 3 |
| Aging | 2 |
| Old | 1 |

In the embodiment of Table 3, the potential effect of technology life cycle 134 ranges from negligible (e.g. approximating zero or the minimum value of the claim strength values shown in Table 1) to about half the maximum value of the claim strength factor 130 (e.g. the maximum value set forth in Table 1 above). This relative scaling means that technology life cycle has a relatively linear effect on the overall market value 130 for the asset 102, but that the total potential effect of the technology life cycle factor 134 is less than that of the claim strength factor 130. Again, other absolute or relative values could be used in other embodiments.

Further, depending upon the type of asset under evaluation, the comparative weight of the technology life cycle may vary. For example, a trademark may have a higher rating if it relates to a mature product or service such as one where the brand is well known and accepted in the marketplace. An example, of such an asset is the trademark for COCA-COLA®. In contrast to a mature trademark, which can have substantial value, a patent covering mature technology may have less relative value because of the well known product life cycle. It is also to be appreciated that an asset having a limited term, as specified in column 110, but that covers a next generation technology may be weighted less than a comparable product having a longer term because the royalty stream associated with the sooner to expire asset would be less. Rules and/or algorithms can be applied, manually or automatically, that take into consideration these relationships when valuing an asset. One such rule for valuing a patent asset may be, for example: if technology life cycle is “next generation” and expiration date is greater than five (5) years, then the weighting factor is “10” otherwise, the weighting factor is “5.” Statistical sampling of known valuations of assets (from example auctions or other open transactions) can be used to more precisely define such interrelationships.

Commercial use factor 136 relates to how widely the asset is implemented in the commercial world. An exemplary guideline for assigning values to the commercial use factor that are consistent with the values contained in the tables above is provided in Table 4:

TABLE 4

| | |
|---|---|
| Pervasive | 5 |
| Common | 3 |
| Specialized | 0 |
| Limited | −3 |
| Few, if any | −5 |

In the embodiment of Table 4, the particular values of commercial use factor 136 are selected to have a lesser overall effect on the overall market value 128 than the claim strength factor 130, but nevertheless to have a significant effect upon the overall market value 128 if adverse conditions are present. Table 4 shows values of the commercial use factor 136 ranging in value between a positive value equal to an average of the minimum and maximum values of claim strength factor 120 and a negative value equal to the inverse of the average claim strength value. Again, other embodiments could use widely varying values, ranges and other criterion for commercial use factor 136.

While the system and method discussed herein relative to FIG. 1 are most aptly applied to the valuation of one or more patents, it is to be appreciated that these valuation tools can also apply to other types of intellectual assets. For example, copyright in a line of software code, a jingle, a rift, a slogan or the like can be used pervasively, or can have few, if any, substantial uses. Similarly, a trademark (such as Mickey Mouse (or the like) can also be used pervasively, where as other trademarks have few if any commercial use.

Prior art factor 138 reflects the effect on market value 128 if questions exist with regard to the asset's validity. For patent assets, for example, validity searching may identify potential issues that could dramatically effect the value of the asset 102, as reflected in the exemplary value guidelines presented in Table 5:

TABLE 5

| | |
|---|---|
| Very unlike that art exists | 5 |
| Somewhat unlikely that art exists | 3 |
| Likely that some art exists | −2 |
| Highly probable that art exists | −8 |
| Known, anticipatory art exists | −10 |

In this exemplary embodiment, the prior art factor 138 has the potential to add value (i.e. an average amount of value) if art is unlikely to exist, but also to subtract a large amount of value to the overall market rating 128 if prior art is known or believed by an evaluator to very likely exist. To that end, the prior art factor 138 shown in Table 5 ranges in value between a positive value equal to an average of the minimum and maximum values for the claim strength factor 120 and a negative value equal to the inverse of the maximum value for the claim strength factor. Again, the non-linear assignment of values within the prior art category can be used to tailor the desired effect of positive or adverse conditions as appropriate and desired. Here the non-linear valuations reflect an appreciation that any knowledge of prior art is inherently limited and the existence or non-existence of invalidating prior art can often only be determined after years of searching, litigation and/or reexamination. Similarly, while known anticipatory art may significantly reduce the value of an asset (as indicated by the −10 factor), in this embodiment, such a rating is not by itself dispositive of the ultimate value of the asset, because while one or even all of the independent claims in a patent may be believed to be invalid over prior art, one or more dependent claims may exist that are value and likely infringed by one or more commercial implementations.

Valuations of the strength of an asset relative to the world of known assets in a given space can also be applied to non-patent assets. For example, a trademark using in whole or in part “Sherlock Holmes” may receive a lesser valuation due to the relative lack of distinctiveness associated with such terms.

The alternative design factor 140 reflects the availability of design-arounds or other alternative technologies that would negate the commercial need for the relevant asset 102. This category could be designed to supplement the information contained within claim strength category 130, as appropriate, or could be intended as a separate category as shown in system 100 of FIG. 1. An exemplary value guideline for the alternative design factor 140 is shown in Table 6:

TABLE 6

| | |
|---|---|
| No known alternatives | 5 |
| Alternative requires substantial research and | 4 |
| development | |
| Alternative known, but difficult | 3 |
| Alternative known, some obstacles exist | 2 |
| Alternative is known and available | 1 |

Note that in the Table 6 embodiment, the values of the alternative design factor generally range from the minimum value to the average possible value of claim strength factor 130, reflecting a potential effect upon the overall market value 128 that is approximately equal to the potential effect of technology life cycle factor 134.

When user-input values for columns 130-140 in system 100 are received, system 100 is able to compute an overall market value 128 based upon the data obtained. In various embodiments, the numerical values for the various factors 130-140 can be simply summed together to reach an overall market value 128, although other embodiments may multiply some or all of the various factors 130-140, or otherwise manipulate the data as appropriate. Further, the values for any given market rating category 130-140 can be weighted based upon demographic parameters, other ratings or the like. That is, the value of any given market rating category can be independent or dependent upon any other category.

The resulting overall market value 128 of an asset 102 can be used in any manner to assign a category name and/or value to that asset 102. In various embodiments, the overall numerical value computed as a function of the various data in columns 130-140 can be compared to one or more thresholds to establish any number of asset categories, which in turn can be assigned to any relevant base value. One set of guidelines for exemplary base values based upon the summed values set forth in Tables 1-6 is presented below in Table 7:

TABLE 7

| TOTAL MKT VALUE | CATEGORY | BASE VALUE |
|---|---|---|
| 30+ | Super | $400k |
| 22-29 | Good | $200k |
| 14-21 | Average | $100k |
| 7-13 | Weak | $50k |
| −6 | Poor | $10k |

To reiterate, the total market value may be calculated in any manner, the various categories associated with the total market value may be determined or assigned in any manner, and the base values associated with each category may vary significantly from embodiment to embodiment. In particular, base values may vary significantly over time (e.g. with inflation and other economic issues), and between technological fields. Base values in the pharmaceutical or medical device fields, for example, may be significantly higher, whereas base values in other less lucrative fields may be lower.

Further, base values can be estimated based upon the relative worth of an intellectual asset to a commercial product, service or the like which incorporates the underlying asset. For example, in an extreme case, the base value of the COCA_COLA trademark is reflected in the operability of the Coca Cola Company's worldwide network of distributors, bottlers, product placement opportunities, marketing expenditures and the like. Thus, when evaluating assets relating to soft drink beverage trademarks one would expect a “Super” valuation (due to the strength of the COCA COLA and PEPSI trademarks) to have a base value in the billions of dollars whereas the valuation of a “Poor” mark (such as one for a lesser known beverage) to be significantly less.

System 100 may further modify the base value associated with the overall market rating 128 of any asset 102 using any suitable technique to arrive at asset value 120. Various other factors, for example, could be used to multiplicatively or otherwise adjust the base values assigned based upon market factors 120-130. In the exemplary embodiment of system 100 shown in FIG. 1, the overall market rating 128 is adjusted by two separate technology factors 124 and 126, as well as by a reference factor 132.

Technology factors 124 and 126 (collectively referenced as factors 122) can be defined in any manner. In an exemplary embodiment, the first technology factor 124 represents the value of the particular technological field covered by asset 102 to the evaluating user. Assets related to any technology, for example, might multiply the base value by a factor of three or more, whereas assets related to technologies of only peripheral (or less) interest may be reduced to ten percent or less of the initial base value. Similarly, a secondary technology rating 126 may be used to further define the value based upon the usefulness of the asset 102 to the analyst's particular interests. The value of assets 102 relating to the analyst's core technologies, for example, would generally not be reduced, and may even be increased by ten percent or so. Conversely, values of technologies that are not related to core or peripheral businesses may be reduced by fifty percent or more. Factors 124 and 126 may not be needed in all implementations of system 100, and these factors may therefore exhibit reduced influence or may even be eliminated in many equivalent embodiments.

Reference factor 142 is any adjustment or scaling factor that is based upon a number of references to asset 102 in subsequent literature. Subsequent patents issuing in any particular field, for example, may make reference to groundbreaking or other important assets in the field. A large number of references to an asset in subsequent publications, then, implies that the asset may have had a pioneering effect upon its technological field, which in turn can lead to increased value. As a result, many embodiments may scale the total market value if a relatively large (or small) number of subsequent references to the asset 102 can be identified in subsequent literature. One set of guidelines for adjusting the base market value 128 in response to subsequent references is presented below in Table 8:

TABLE 8

| | |
|---|---|
| 100+ references in subsequent literature | ×1.5 |
| 50-99 references | ×1.25 |
| 20-49 references | 0 |
| 10-19 references | ×.75 |
| 0-9 references | ×.5 |

The rightmost column of Table 8 shows an appropriate multiplier to be applied for the identified number of subsequent references. The multipliers and the particular numbers of references defining the categories of Table 8 may be adjusted in any manner. Additionally, in some embodiments, the scaling effect of reference factor 142 may be reduced for assets 102 that are relatively new (e.g. have been issued for eight to ten years or less), or relatively old (e.g. issued for fifteen years or more). The age of the asset 102 may be manually or automatically determined in any manner. Similarly, various embodiments may automatically obtain the number of references citing any particular asset 102 from an online database or any other source as appropriate.

System 100 therefore determines the cost of the various assets 102A-C using data supplied by the user or obtained automatically with respect to market factors 130-140, technological factors 124 and 126, and/or reference factor 142 as appropriate. The values 120 for the individual assets 102A-C may be readily summed or otherwise collectively represented by an aggregate portfolio value 148 as appropriate.

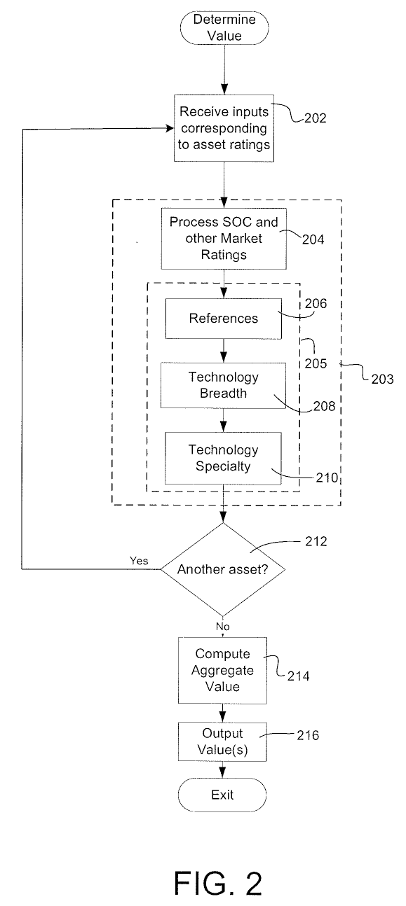

FIG. 2 shows an exemplary process 200 for determining the value of a portfolio of assets. With reference now to FIG. 2, the exemplary process shown therein includes the broad steps of receiving inputs from the user(s) corresponding to the various asset ratings (step 202), determining the values of individual assets using the values received (step 203), computing an aggregate value (step 214) for the portfolio, and providing the aggregate value as an output (step 216) in any appropriate manner. As noted above, the various asset values 120 and aggregate portfolio value 148 may be computed in real-time or otherwise using conventional spreadsheet data processing features, or any other techniques as appropriate. To that end, the various steps of process 200 need not occur serially in practice, but rather may take place concurrently or in a different order from the exemplary logic shown in the diagram. Further, it should be noted that the various processing blocks in FIG. 2 need not be discretely present in all practical embodiments, but rather are intended to represent various processing steps that may be physically and/or logically implemented in any manner. The techniques shown in FIG. 2 may be implemented using any programmed or programmable logic, including any sort of computer system, calculator, personal digital assistant, portable phone or other processor-driven device. Similarly, any software or firmware logic used to direct the execution of process 200 (or any portion thereof) may be stored in any kind of digital storage media, including any sort of digital memory, optical or magnetic storage, portable media, and/or the like.

Step 202 simply involves receiving inputs from the user, as noted above. Inputs may be provided into a conventional spreadsheet (e.g. into columns 124-142 in system 100 shown in FIG. 1), or into any other appropriate interface in any manner. The inputs may be numeric in nature as entered, or may be converted to numeric values in any manner. As noted above, the inputs received from the user provide ratings for each asset 102A-C with respect to any number of categories 124-142.

The inputs received in step 202 are suitably processed in step 203 to compute a value (corresponding to asset value 120 in FIG. 1) for each of the intellectual assets 102 in the portfolio. The computation of values 120 may be performed in any manner, using any spreadsheet or other computer resources. In various embodiments, step 203 suitably includes processing the claim strength and other market ratings (step 204), and performing any desirable adjustments (step 205) for technology ratings (steps 208, 210) and/or references in subsequent publications (step 206). Step 203 may be executed in the context of an asset portfolio, as shown in FIG. 2, or may be equivalently executed as a single process to compute a single value 120 corresponding to a lone asset 102 that may not be part of a portfolio, or that may have value apart from the portfolio of other assets 102. When applied to a portfolio of common assets (e.g., 20 patents), however, it is generally desirable that the same rating and weighting factors are applied consistently throughout the portfolio.

The market-related factors (columns 130-140 in FIG. 1) can be processed in any manner (step 204). As noted above, various embodiments simply receive ranged inputs for the various factors that can be added together and compared to a range of threshold values to place the asset 102 into an asset category with a base value. In other embodiments, inputs received from the user in step 202 are scaled or converted as appropriate prior to processing. Further, the “base value” of any asset 102 can be computed in any manner, and need not be limited to the category/threshold technique described above.

Adjustment step 205 suitably includes performing any adjustments to the base value to accommodate subsequent reference factors (step 206), technology breadth factors (step 208) and/or technology specialty factors (step 210) as appropriate and desired for the embodiment. Exemplary techniques for processing such factors are described above in conjunction with columns 142, 124 and 126 of system 100, respectively.

The asset values computed in step 203 may be output to a storage or display device as appropriate. In various embodiments, steps 202 and 203 are repeated (step 212) for each of the assets 102 in a portfolio so that an aggregate portfolio value can be determined (step 214) and output to the user (step 216) in any manner. In spreadsheet-based embodiments, for example, step 216 may include calculating or updating values presented in aggregate value cell 148 (FIG. 1), as well as calculating or updating values in column 120. Values may be additionally or otherwise output to a storage file, hardcopy and/or other format as desired by the user and as appropriate for the particular embodiment.

Further, the technology, market, reference and/or other rating factors can be combined in various combinations to obtain asset valuation ranges. For example, a market value multiplied by a reference rating might result in a high valuation, whereas a market value multiplied by a technology rating and/or a specialty rating might result in a low valuation. By utilizing various combinations of ratings, valuation ranges can be obtained. Such valuation ranges can be used to dictate purchasing behavior at auctions, during licensing negotiations, and/or during any other like events.

While at least one exemplary embodiment has been presented in the foregoing detailed description, it should be appreciated that a vast number of alternate but equivalent variations exist. Although the systems and techniques described herein are frequently described with respect to computer spreadsheet implementations, for example, similar concepts could be readily applied with any other software applications, programming or scripting languages, formats, environments, protocols and the like. Similarly, as noted at the outset, the invention is not limited to embodiments that consider only United States patents, but rather may be broadly implemented to consider any range of other intellectual assets (e.g. industrial designs, copyrights, trademarks, trade dress, trade secrets and/or the like), including any assets that may be domestic or foreign to any particular jurisdiction.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method of determining an aggregate value of a portfolio of intellectual assets based upon a plurality of ratings, each rating determined with respect to one of a plurality of categories for each of the intellectual assets in the portfolio, wherein the plurality of categories comprises a category representing a claim strength of each of the plurality of intellectual assets, the method comprising:
receiving a plurality of inputs for each of the intellectual assets in the portfolio, each input corresponding to one of the plurality of ratings assigned to the intellectual asset;
computing a value for each of the intellectual assets as a function of the input representing the claim strength of the intellectual asset adjusted by the other inputs for that intellectual asset; and
outputting the aggregate value of the portfolio of intellectual assets as a function of the values of each of the intellectual assets in the portfolio.

2. The method of claim 1 wherein at least some of the categories correspond to a plurality of market ratings.

3. The method of claim 2 wherein the plurality of market ratings comprise at least one of an observability factor, a technology life cycle factor, a commercial use factor, a prior art factor, and an alternative use factor.

4. The method of claim 2 wherein the plurality of market ratings comprise each of an observability factor, a technology life cycle factor, a commercial use factor, a prior art factor, and an alternative use factor.

5. The method of claim 2 wherein the processing step comprises determining an overall market rating for each of the plurality of intellectual assets as a function of the plurality of market ratings and the claim strength associated with that intellectual asset.

6. The method of claim 5 wherein the processing step further comprises computing the value of each intellectual asset by further adjusting the overall market rating in response to a citation rating corresponding to a number of subsequent references to the intellectual asset.

7. The method of claim 5 wherein the processing step further comprises computing the value of each intellectual asset by adjusting the overall market rating in response to a first technology rating corresponding to one of the plurality of inputs, wherein the first technology rating represents a breadth of technology affected by the intellectual asset.

8. The method of claim 7 wherein the processing step further comprises computing the value of each intellectual asset by further adjusting the overall market rating in response to a second technology rating corresponding to a second one of the plurality of inputs, wherein the second technology rating represents a specialty technology affected by the intellectual asset.

9. The method of claim 1 wherein the categories are pre-defined based upon criteria.

10. The method of claim 9 wherein at least some of the criteria are objectively-defined.

11. The method of claim 10 wherein at least some of the plurality of ratings correspond to subjective evaluations of the asset based upon the criteria.

12. The method of claim 1 wherein the computing step comprises determining a range of values for each of the plurality of assets.

13. The method of claim 1 further comprising the step of determining a range of potential values for the aggregate value of the portfolio of intellectual assets.

14. A computer-readable medium having software instructions stored thereon, the software instructions configured to execute the method of claim 1.

15. A computer program product stored in a digital storage medium, the computer program product comprising:
a first code module configured to receive a plurality of inputs for each of the intellectual assets in the portfolio, each input corresponding to a rating of the intellectual asset with respect to one of a plurality of categories, wherein the plurality of categories comprises a category representing a claim strength of the intellectual asset;
a second code module configured to determine a value for each of the intellectual assets as a function of the input associated with the claim strength of the intellectual asset as adjusted by the other inputs for that intellectual asset; and
a third code module configured to output an aggregate value of the portfolio of intellectual assets as a function of the values of each of the intellectual assets in the portfolio.

16. The computer program product of claim 15 wherein the first, second and third code modules are implemented within a computer spreadsheet application.

17. A method of determining a value of an intellectual asset based upon a plurality of ratings, each rating determined with respect to one of a plurality of categories, wherein the plurality of categories comprises a plurality of market-related categories, the method comprising:
receiving a plurality of inputs, each input corresponding to one of the plurality of ratings assigned to the intellectual asset;
aggregating each of the inputs received with respect to the market-related categories for the asset to thereby compute an overall market rating for the intellectual asset; and
outputting the value of the intellectual asset as a function of the overall market rating of the intellectual asset.

18. The method of claim 17 wherein the market-related categories comprise a claim strength factor ranging in value between a minimum value and a maximum value.

19. The method of claim 18 wherein the market-related categories further comprise an observability factor ranging in value between a positive value equal to an average of the minimum and maximum values and a negative value equal to the inverse of the average of the minimum and maximum values.

20. The method of claim 18 wherein the market-related categories further comprise a technology life cycle factor ranging in value between the minimum value and an average of the minimum and maximum values.

21. The method of claim 18 wherein the market-related categories further comprise a commercial use factor ranging in value between a positive value equal to an average of the minimum and maximum values and a negative value equal to the inverse of the average of the minimum and maximum values.

22. The method of claim 18 wherein the market-related categories further comprise a prior art factor ranging in value between a positive value equal to an average of the minimum and maximum values and a negative value equal to the inverse of the maximum value.

23. The method of claim 18 wherein the market-related categories further comprise an alternatives factor ranging in value between the minimum value and an average of the minimum and maximum values.

24. The method of claim 18 wherein the overall market rating is a sum of the inputs received with respect to the market-related categories for the asset, and wherein the value of the intellectual asset is determined by comparing the sum of the inputs to a plurality of thresholds to thereby assign a base value to the asset.

25. The method of claim 24 further comprising adjusting the base value in response to a citation rating corresponding to a number of subsequent references to the intellectual asset.

26. The method of claim 24 further comprising adjusting the base value in response to a first technology rating corresponding to one of the plurality of inputs, wherein the first technology rating represents a breadth of technology affected by the intellectual asset.

27. The method of claim 24 further comprising adjusting the base value in response to a second technology rating corresponding to a second one of the plurality of inputs, wherein the second technology rating represents a specialty technology affected by the intellectual asset.

28. The method of claim 17 wherein at least some of the categories are pre-defined at least in part based upon objectively-defined criteria.

29. The method of claim 28 wherein at least some of the plurality of ratings correspond to subjective evaluations of the asset based upon the objectively-defined criteria.

30. The method of claim 17 wherein the computing step comprises determining a range of values for each of the plurality of assets.

31. A computer-readable medium having software instructions stored thereon, the software instructions configured to execute the method of claim 17.
